(19) United States
(12) Patent Application Publication
(10) Pub. No.: US 2010/0027063 A1
(43) Pub. Date: Feb. 4, 2010

(54) INFORMATION PROCESSING APPARATUS

(75) Inventor: Hidehito JINGU, Tokyo (JP)

Correspondence Address: MOTS LAW, PLLC, 1629 K STREET N.W., SUITE 602, WASHINGTON, DC, 20006-1635, US

(73) Assignee: Oki Data Corporation, Tokyo (JP)

(21) Appl. No.: 12/509,802

(22) Filed: Jul. 27, 2009

(30) Foreign Application Priority Data
Jul. 30, 2008 (JP) JP2008-196919

(51) Int. Cl. G06F 15/00

(52) U.S. Cl. 358/1.15

(57) ABSTRACT

An information processing apparatus capable of participating in an information processing apparatus having plural information processing apparatuses communicating with one another via a network. The information processing apparatus includes a network control unit capable of being connected to the network; an error monitor configured to monitor if an error exists in the information processing apparatus; and a controller configured to request another information processing apparatus to execute a function which is inexecutable due to an error in the information processing apparatus.

### CROSS REFERENCE TO RELATED APPLICATIONS

This application claims priority based on 35 USC 119 from prior Japanese Patent Application No. 2008-196919 filed on Jul. 30, 2008, entitled “Information Processing Apparatus”, the entire contents of which are incorporated herein by reference.

### BACKGROUND OF THE INVENTION

1. Field of the Invention

The invention relates to an information processing apparatus used with a personal computer (PC) or a facsimile.

2. Description of Related Art

Recently, an MFP (Multi Function Printer), which has a scanner unit and a fax interface to perform copy and fax functions as well as a printing function, has been widely used, as a substitute for an SFP (Single Function Printer) which has only a printing function (see Japanese Patent Application Laid-Open No. H10-198532, for example). This MFP offers advantages to a user who generally uses the MFP as a printer but sometimes as a copier.

### SUMMARY OF THE INVENTION

However, regarding the MFP, there has been a problem that the MFP cannot be used continuously when an error occurs in one of the multiple functions. For example, when the scanner unit is out of order, functions such as copying and fax transmission, which require scanning, cannot be executed.

A first aspect of the invention provides an information processing apparatus for use in an information processing system wherein plural information processing apparatuses communicates with one another via a network. The information processing apparatus includes: a network control unit capable of being connected to the network; an error monitor configured to monitor if an error exists in the information processing apparatus; and a controller configured to request another information processing apparatus to execute a function which is inexecutable due to an error in the information processing apparatus.

According to the first aspect of the invention, the information processing apparatus can share executable functions with another information processing apparatus so that an information processing system can be used continuously even when an error occurs in one of the image processing apparatuses.

A second aspect of the invention provides an information processing system comprising a first information processing apparatus communicating with a second information processing apparatus via a network. The first information processing apparatus comprises: a first network control unit connected to the network, a first error monitor configured to monitor if an error exists in the first information processing apparatus, a first controller configured to request the second information processing apparatus to execute a function which is inexecutable in the first information processing apparatus due to an error in the first information processing apparatus. The second information processing apparatus comprises: a second network control unit connected to the network, a second error monitor configured to monitor if an error exists in the second information processing apparatus, and a second controller configured to request the first information processing apparatus to execute a function that is inexecutable in the second information processing apparatus in response to an error in the second information processing apparatus.

According to the second aspect of the invention, each information processing apparatus can share executable functions with another information processing apparatus so that the information processing system can be used continuously even when an error occurs in one of the image processing apparatuses.

According to the second aspect of the invention, each information processing apparatus can share executable functions with another information processing apparatus so that the information processing system can be used continuously even when an error occurs in one of the image processing apparatuses.

### BRIEF DESCRIPTION OF THE DRAWINGS

FIG. 1 is a block diagram of a configuration of an image processing system according to a first embodiment.

FIG. 2 is a diagram of a web page for setting information of a transfer destination information storage unit in MFP 1.

FIG. 3 is a diagram of a data transfer packet sent from MFP 1 to MFP 2.

FIG. 4 is an operation flowchart of MFP 1 according to the first embodiment.

FIG. 5 is an operation flowchart of a proxy function execution process of MFP 1 according to the first embodiment.

FIG. 6 is a block diagram of a configuration of an MFP according to a second embodiment of the invention.

FIG. 7 is a diagram of how MFP 1 acquires information from an executable function information storage unit in MFP 2.

FIG. 8 is a diagram of how MFP 2 acquires information from an executable function information storage unit in MFP 1.

FIG. 9 is an operation flowchart of an update process in the executable function information storage unit of MFP 1 according to the second embodiment.

FIG. 10 is an operation flowchart of an update process in a transfer destination information storage unit of MFP 1 according to the second embodiment.

### DETAILED DESCRIPTION OF EMBODIMENTS

Descriptions are provided hereinbelow for Embodiments based on the drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on the Embodiments. For this reason, specific dimensions and the like should be interpreted with the following descriptions taken into consideration. In addition, the drawings include parts whose dimensional relationship and ratios are different from one drawing to another.

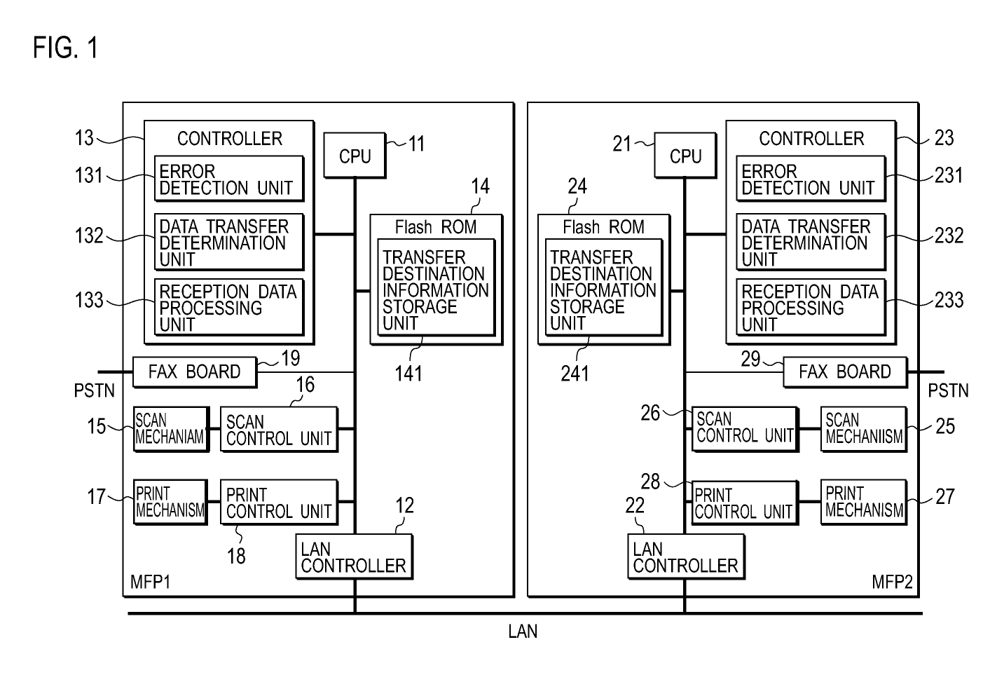

Embodiments of an information processing system according to the invention will be described with reference to FIGS. 1 to 10. These embodiments are described with a multi function printer (hereinafter, referred to as MFP) as an information processing apparatus.

### First Embodiment

FIG. 1 shows a configuration of an image processing system of a first embodiment. In FIG. 1, plural MFPs (two MFPs which are MFP 1, MFP 2 in this embodiment) are communicatably connected via a network (which is a LAN, in the embodiment).

MFP 1 has CPU 11, LAN controller 12, controller 13, Flash ROM 14, scan mechanism 15 configured to optically read data (original), scan control unit 16 configured to control scan mechanism 15, print mechanism 17 having a paper handling mechanism, print head and the like and configured to print data on a medium, print control unit 18 configured to control print mechanism 17, and faxboard 19 connected to a PSTN (public switched telephone network) line.

Since MFP 2 has the same structure as that of MFP 1, the description regarding MFP 2 will be omitted.

Controller 13 has error detection unit 131 configured to detect the occurrence of an error in the MFP (MFP 1), data transfer determination unit 132 configured to determine whether or not to transfer data to the other MFP (MFP 2) on the LAN and perform a process for the transfer, and reception data processing unit 133 configured to receive data transferred from the other MFP and process the received data. According to the embodiment, controller 13 is composed of a ROM (read-only memory) storing control programs to execute the respective operations of error detection unit 131, data transfer determination unit 132, and reception data processing unit 133.

Flash ROM 14 is a writable ROM and has transfer destination information storage unit 141 for managing and storing error types occurring in the MFP (MFP 1) and a transfer destination (MFP 2) to which data is transferred when an error occurs in the MFP (MFP 1) for each error type. Flash ROM 14 can store data read by scan mechanism 15.

Next, operating procedures of the MFPs having the above configuration will be described with reference to FIGS. 1 to 3 and Tables 1 to 3.

Firstly, operations of MFP 1 will be described based on an assumption that a paper-out error occurs in MFP 1 when a user executes a copy using MFP 1.

Usually, data scanned by scan mechanism 15 in response to a user operation is sent to print control unit 18 via scan control unit 16 and printed in print mechanism 17. However, when error detection unit 131 detects a paper-out condition, the scanned data is sent to LAN controller 12 by data transfer determination unit 132 and then transferred to the other MFP (MFP 2) via LAN. Here, the data transfer to the other MFP is executed according to information stored in transfer destination information storage unit 141 of the MFP (MFP 1).

Table 1 shows an example of data stored in transfer destination information storage unit 141 of MFP 1.

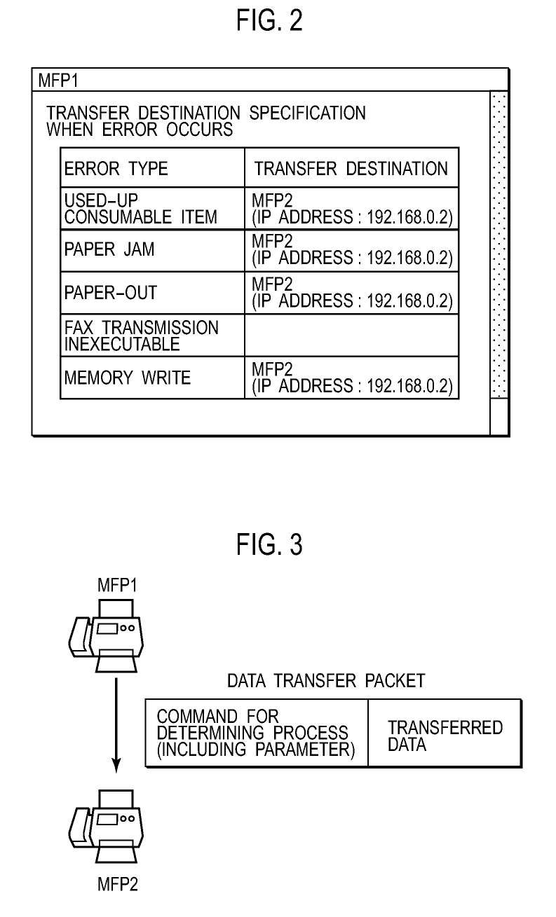

In this example, it is assumed that, when a depleted consumable item, a paper jam, a paper-out, a memory write error or the like occurs, data is transferred to MFP 2 serving as the other MFP. Here, according to the embodiment, information stored in transfer destination information storage unit 141 is previously set by the user using a web page of MFP 1. FIG. 2 shows an example of a web page for setting information of transfer destination information storage unit 141 of MFP 1.

Note that the memory write error means a write operation error in Flash ROM 14.

When data is transferred from MFP 1 to MFP 2, a command and a parameter, which are used for determining a process, are applied to the transferred data in MFP 1 as shown in FIG. 3 and Table 2. FIG. 3 shows a data transfer packet sent from MFP 1 to MFP 2 and Table 2 shows examples of commands and parameters, which are used for determining a process and attached to data transfer packets. Here, a command of “1” and a parameter of “number of copies” are applied in order to request MFP 2 to print.

In MFP 2, LAN controller 22 receives the data transferred from MFP 1 and reception data processing unit 233 of controller 23 analyzes the received data. When it is determined that printing is requested according to a result of analyzing the command attached to the data, the received data is sent to print control unit 28 and print mechanism 27 prints the data based on the number of copies specified by the parameter.

TABLE 1

| ERROR TYPE | TRANSFER DESTINATION |
|---|---|
| USED-UP CONSUMABLE ITEM | MFP2(IP ADDRESS: 192.168.0.2) |
| PAPER JAM | MFP2(IP ADDRESS: 192.168.0.2) |
| PAPER-OUT | MFP2(IP ADDRESS: 192.168.0.2) |
| FAX TRANSMISSION | — |
| INEXECUTABLE | |
| MEMORY WRITE | MFP2(IP ADDRESS: 192.168.0.2) |

TABLE 2

| COMMAND | PARAMETER | PROCESS TO BE EXECUTED |
|---|---|---|
| 0 | N/A | DISCARD(REMOVE |
| | | RECEIVED DATA) |
| 1 | NUMBER OF COPIES | PRINT |
| 2 | DESTINATION | FAX TRANSMISSION |
| | TELEPHONE | |
| | NUMBER | |
| 3 | N/A | MEMORY WRITE |

Next, operating procedures will be described based on an assumption that a fax transmission inexecutable error occurs in MFP 2 when the user requests a fax transmission using MFP 2.

Normally, the data scanned by scan mechanism 25 in response to the user request is sent to fax board 29 via scan control unit 26 to transmit the data to a specified destination on the PSTN line; however, when error detection unit 231 detects a fax transmission inexecutable error, data transfer determination unit 232 sends the read data to LAN controller 22 and then the data is transferred to MFP 1 as the other MFP according to information of transfer destination information storage unit 241.

Table 3 shows an example of data stored in transfer destination information storage unit 241 of MFP 2.

In this example, it is assumed that, when a depleted consumable item error, a paper jam error, a paper-out error, a fax transmission inexecutable error or the like occurs, data is transferred to MFP 1 serving as the other MFP. Here, according to the embodiment, information stored in transfer destination information storage unit 241 is previously set by the user using a web page of MFP 2.

TABLE 3

| ERROR TYPE | TRANSFER DESTINATION |
|---|---|
| USED-UP CONSUMABLE ITEM | MFP1(IP ADDRESS: 192.168.0.1) |
| PAPER JAM | MFP1(IP ADDRESS: 192.168.0.1) |
| PAPER-OUT | MFP1(IP ADDRESS: 192.168.0.1) |
| FAX TRANSMISSION | MFP1(IP ADDRESS: 192.168.0.1) |
| INEXECUTABLE | |
| MEMORY WRITE | — |

When data is transferred from MFP 2 to MFP 1, a command and a parameter, which are used for determining a process, are attached to the head of the transferred data in MFP 2. The attached command and parameter are shown in a forementioned FIG. 3 and Table 2. Here, a command “2” and a parameter “destination telephone number” are applied in order to request MFP 1 to send a fax transmission.

In MFP 1, LAN controller 12 receives the data transferred from MFP 2 and reception data processing unit 133 analyzes the received data. When it is determined that a fax transmission is requested based on a result of the analysis of the command attached to the data, the data is sent to faxboard 19 and faxboard 19 transmits the data to a destination on the PSTN line which is specified by the parameter.

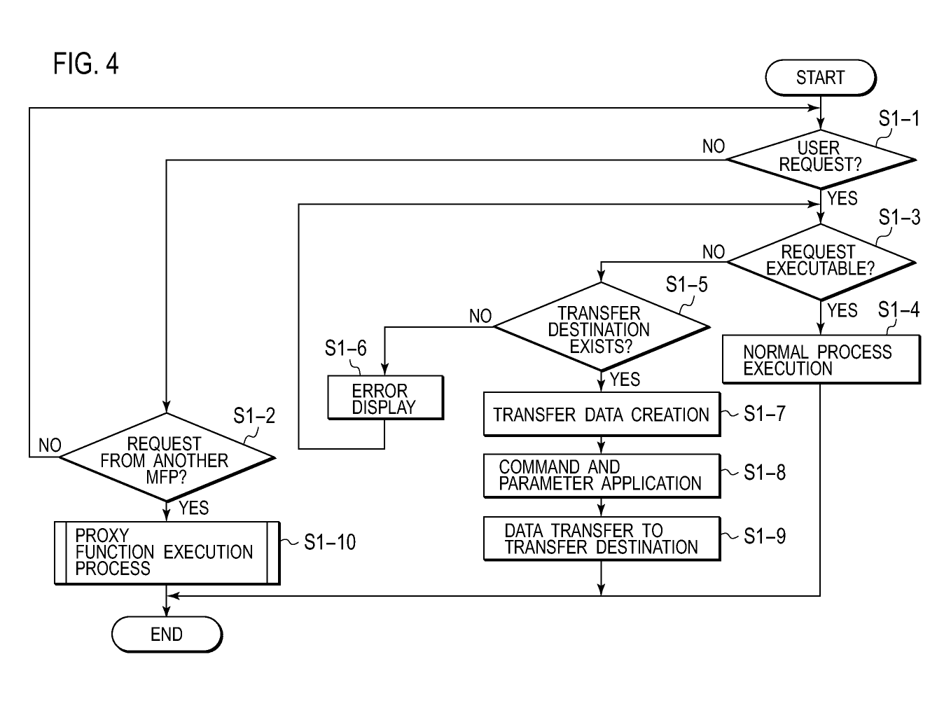

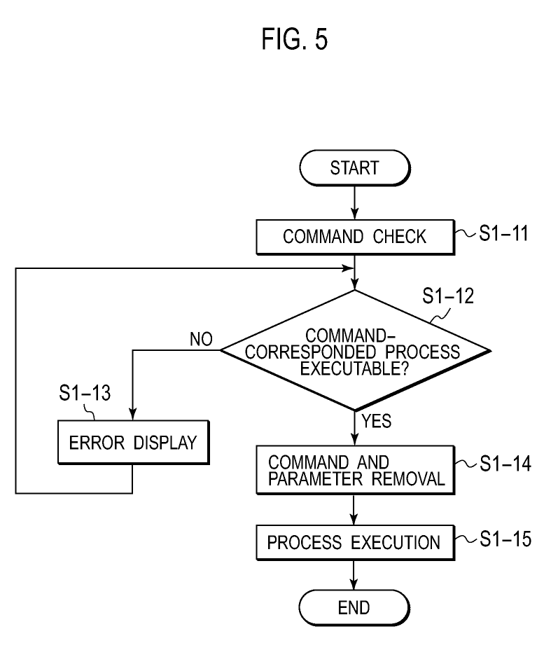

The above-described operating procedures of the MFP will further be described with reference to operation flowcharts of FIGS. 4 and 5. FIG. 4 is an operation flowchart of MFP 1 and FIG. 5 is an operation flowchart of the proxy function execution process shown in FIG. 4. Note that the following process is executed by a control program stored in controller 13.

MFP 1 waits for a request of an execution (an execution of a copy or a fax transmission, for example) specified from a user in step S1-1 of FIG. 4 or for a request of the above execution from another MFP (MFP 2) in step S1-2.

When MFP 1 receives a request specified by the user in step S1-1. error detection unit 131 checks if there is any error that interferes with the execution of the requested process in step S1-3. If no error is detected, a normal process (a process of a copy function or a fax transmission function) is executed in step S1-4. If an error is detected, information of transfer destination, to which the execution of process is requested, is acquired from transfer destination information storage unit 141 in step S1-5.

When the transfer destination information cannot be acquired in step S1-5, MFP 1 executes a normal error process (error notification) in step S1-6 and waits until it is recovered from the error interfering with the execution of the requested process as repeating steps S1-6, S1-3 and S1-5 in order. When the transfer destination information is acquired, the process proceeds to step S1-7 and MFP 1 executes a normal process which is before the inexecutable process due to the error so that transfer data is created. Next, in step S1-8, a command and a parameter (see Table 2), which indicate an inexecutable function due to the error, are attached to the head of the created data and, in step S1-9, the data including the command and parameter is sent to a transfer destination (MFP 2) via LAN control unit 12. Note that, the processes from step S1-5 to step S1-9 are executed by data transfer determination unit 132.

Further, when LAN control unit 22 receives a process execution request from another MFP (MFP 2) in step S1-2, a proxy function execution process is executed in step S1-10.

The proxy function execution process is executed according to the operation flowchart of FIG. 5.

In step S1-11 of FIG. 5, reception data processing unit 133 checks a command which is attached to the head of data in aforementioned step S1-8. In step S1-12, error detection unit 131 checks whether an error, which interferes with the process corresponding to the command, occurs in the MFP (MFP 1).

When an error is detected by error detection unit 131, the process proceeds to step S1-13 and MFP 1 executes a normal error process (error display) and waits until the error, which interferes with the requested process, is removed from the MFP (MFP 1). When no error is detected, the process proceeds to step S1-14, the command and parameter are removed from the received data and the parameter (see Table 2) is sent to a control unit (for example, scan control unit 16 or print control unit 18), which executes a function corresponding to the command in step S1-15. Then the control unit controls and executes the process requested by another MFP (MFP 2).

Note that, since operating procedures of MFP 2 are the same as those of MFP 1, the explanation will be omitted here.

As described above, according to the first embodiment, even when a particular function of MFP 1 is not executable due to an error in MFP 1, for example, the process is executed by another MFP in the network (LAN) instead of MFP 1 if the other MFP is available. With this configuration, a user can use MFP 1 continuously without regard to errors.

Further, even when each MFP on the network has one or more errors, executable functions are shared among all the MFPs so that those MFPs can be used continuously.

### Second Embodiment

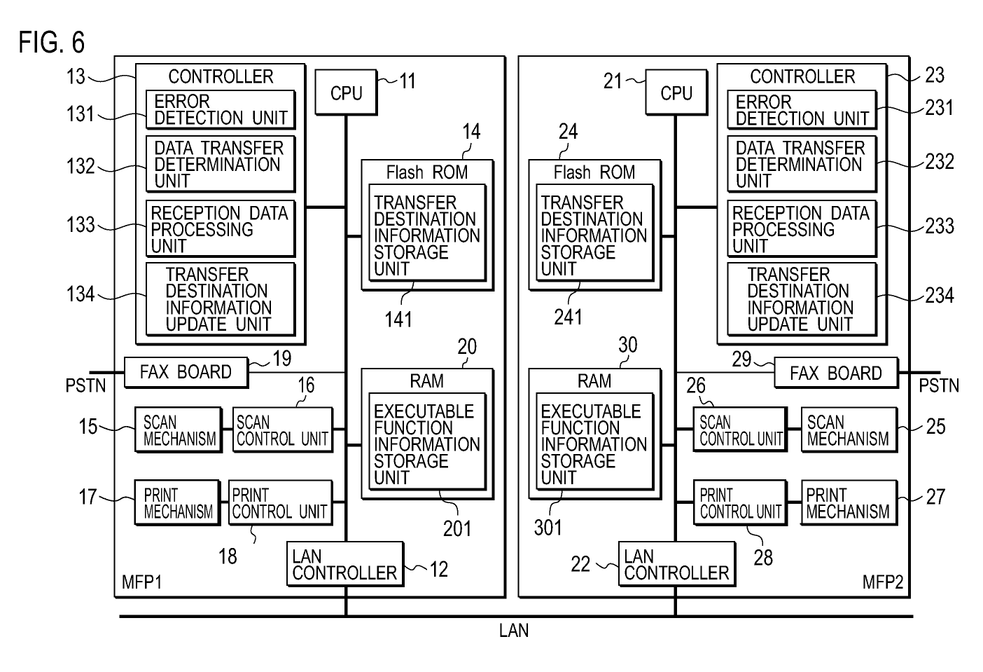

FIG. 6 shows a configuration of MFPs according to a second embodiment of the invention. In FIG. 6, the same reference numbers are applied to the components which are the same as in the first embodiment (FIG. 1).

In FIG. 6, the references 1, 2 denote MFPs and these two MFP 1 and MFP 2 are communicatably connected to each other via a network (a LAN, in this embodiment).

The configuration of the MFPs of the second embodiment is the same as those of the first embodiment (FIG. 1). The differences from the first embodiment are that MFP 1 of the second embodiment has transfer destination information update unit 134 configured to update destination information as to where controller 13 transfers data (information in transfer destination information storage unit 141) and RAM 20 (random access memory) connected to a bus of CPU 11. RAM 20 has executable function information storage unit 201 configured to manage and store a list of functions which are currently executable in the MFP 1.

Here, MFP 2 has the same configuration as MFP 1 and the explanation will be omitted.

Next, operating procedures of the MFPs having the above configuration will be described with reference to FIGS. 6 to 8 and Tables 4 to 9.

The operating procedures will be described based on an assumption that a paper-out error occurs in MFP 1 when the user executes a copy using MFP 1.

Normally, the data read by scan mechanism 15 in response to user operation is sent to print control unit 18 via scan control unit 16 and print mechanism 17 prints the data. When error detection unit 131 detects a paper-out, the read data is sent to LAN control unit 12 by data transfer determination unit 132 and transferred to another MFP (MFP 2) via the LAN. The data transfer to the other MFP is executed based on the information stored in transfer destination information storage unit 141 in MFP 1.

The data stored in transfer destination information storage unit 141 of MFP 1 is shown in aforementioned Table 1.

In this example, it is assumed that, when a depleted consumable item error, a paper jam error, a paper-out error, a memory write error or the like occurs, data is transferred to MFP 2 serving as the other MFP.

Note that the memory write error means a write operation error in Flash ROM 24.

In the second embodiment, information in transfer destination information storage unit 141 is updated at intervals by transfer destination information update unit 134.

In other words, transfer destination information update unit 134 periodically monitors the content of executable function information storage unit 301 of the other MFP (MFP 2) via the LAN. When there is a change in the content, transfer destination information update unit 134 acquires the information and updates the information in transfer destination information storage unit 141 based on the acquired information. In MFP 2, the error detection unit 231 updates the content in executable function information storage unit 301 every time an error occurs in and is removed from the MFP 2.

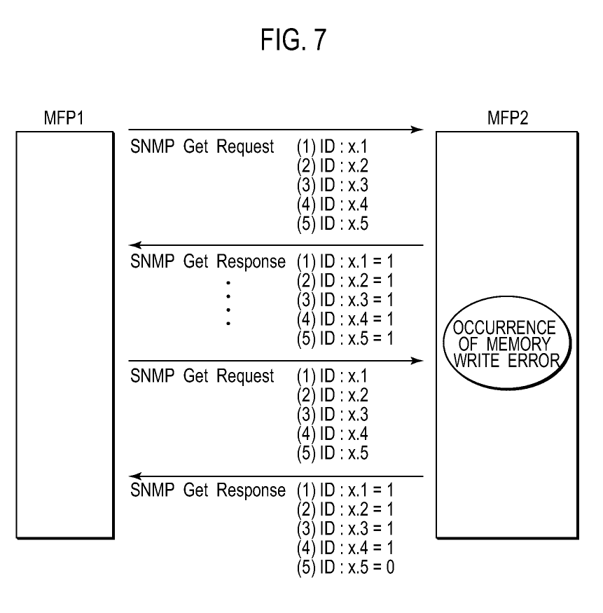

Tables 4 and 5 show examples of an update in executable function information storage unit 301 of MFP 2; Table 4 shows a condition before an error occurs; and Table 5 shows a condition after the error occurs. These examples assume an occurrence of a memory write error. Further, FIG. 7 shows an example of how transfer destination information update unit 134 of MFP 1 acquires information from executable function information storage unit 301 of MFP 2 and a memory write error “ID:X.5=0” in the MFP 2 is acquired corresponding to aforementioned Tables 4 and 5.

As described above, since the content in executable function information storage unit 301 of MFP 2 is changed to show that “memory write” is “inexecutable”, the information in transfer destination information storage unit 141 shown in Table 1 is updated to show that there is “none” of “transfer destination” for “memory write” as shown in Table 6.

TABLE 4

| | | EXECUTABLE(1)/ |
|---|---|---|
| ID | FUNCTION | INEXECUTABLE(0) |
| X.1 | PRINT | 1 |
| X.2 | SCAN | 1 |
| X.3 | FAX TRANSMISSION | 1 |
| X.4 | FAX RECEPTION | 1 |
| X.5 | MEMORY WRITE | 1 |

TABLE 5

| | | EXECUTABLE(1)/ |
|---|---|---|
| ID | FUNCTION | INEXECUTABLE(0) |
| X.1 | PRINT | 1 |
| X.2 | SCAN | 1 |
| X.3 | FAX TRANSMISSION | 1 |
| X.4 | FAX RECEPTION | 1 |
| X.5 | MEMORY WRITE | 0 |

TABLE 6

| ERROR TYPE | TRANSFER DESTINATION |
|---|---|
| USED-UP CONSUMABLE ITEM | MFP2(IP ADDRESS: 192.168.0.2) |
| PAPER JAM | MFP2(IP ADDRESS: 192.168.0.2) |
| PAPER-OUT | MFP2(IP ADDRESS: 192.168.0.2) |
| FAX TRANSMISSION | — |
| INEXECUTABLE | |
| MEMORY WRITE | — |

When a data transfer is executed from MFP 1 to MFP 2, a command and a parameter, which are used to determine a process, are attached to the head of the transferred data in MFP 1 as shown aforementioned FIG. 3 and Table 2. In this example, a command of “1” for requesting MFP 2 to print and a parameter of “number of copies” are applied.

In MFP 2, LAN control unit 22 receives data transferred from MFP 1 and reception data processing unit 233 of controller 23 analyzes the received data. When it is determined that printing is requested according to the result of analyzing the command attached to the data, the received data is sent to print control unit 28 and printed by print mechanism 27 according to the number of copies specified by the parameter.

Next, operating procedures will be described on an assumption that a fax transmission inexecutable error exists in MFP 2 when a user requests a fax transmission using MFP 2.

Normally, the data read by scan mechanism 25 in response to the user operation is sent to fax board 29 via scan control unit 26 and then to a specified destination on the PSTN line. When error detection unit 231 detects a fax transmission inexecutable error, data transfer determination unit 232 sends the read data to LAN control unit 22 and the data is transferred to MFP 1 serving as the other MFP according to the information in transfer destination information storage unit 241.

Table 3 shows the data stored in transfer destination information storage unit 241 of MFP 2.

In this example, it is assumed that a depleted consumable item error, a paper jam error, a paper-out error, a fax transmission inexecutable error or the like occurs and data is transferred to MFP 1.

According to the second embodiment, the information of transfer destination information storage unit 241 is updated at intervals by transfer destination information update unit 234.

In other words, transfer destination information update unit 234 periodically monitors the content of executable function information storage unit 201 of the other MFP (MFP 1) on the LAN. When a change is found in the content, transfer destination information update unit 234 acquires the information and updates transfer destination information storage unit 241 according to the acquired information.

In MFP 1, error detection unit 131 updates the content in executable function information storage unit 201 every time when an error occurs in or is removed from the MFP 1.

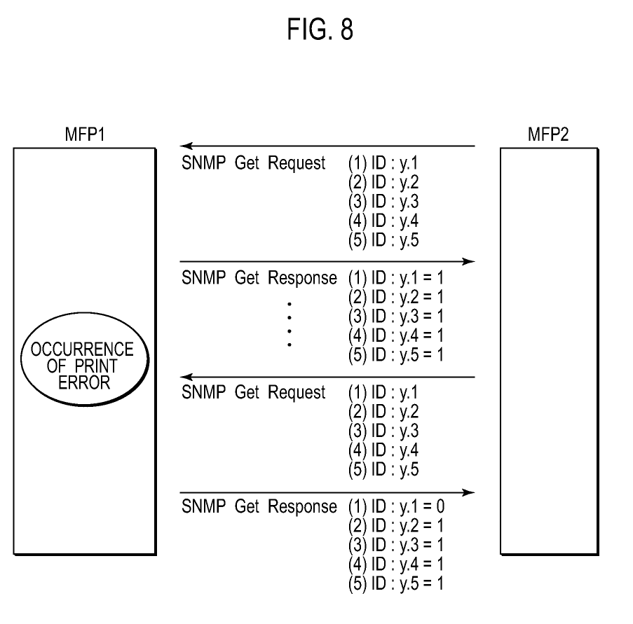

Tables 7 and 8 show an example of how executable function information storage unit 201 updates in MFP 1; Table 7 shows a condition before an error occurs; and Table 8 shows a condition after the error occurs. This example assumes an occurrence of a printing error. FIG. 8 shows an example of how transfer destination information update unit 234 of MFP 2 acquires information from executable function information storage unit 201 in MFP 1 and it is assumed that a print error of “ID:Y.1=0” in MFP 1 is acquired corresponding to aforementioned Tables 7 and 8.

As described above, since the content of executable function information storage unit 201 of MFP 1 is changed to show that “print” is “inexecutable”, the information in transfer destination information storage unit 241 shown in Table 3 is updated to show that there is “none” of “transfer destination” for “print” as shown in Table 9.

TABLE 7

| | | EXECUTABLE(1)/ |
|---|---|---|
| ID | FUNCTION | INEXECUTABLE(0) |
| Y.1 | PRINT | 1 |
| Y.2 | SCAN | 1 |
| Y.3 | FAX TRANSMISSION | 1 |
| Y.4 | FAX RECEPTION | 1 |

TABLE 8

| | | EXECUTABLE(1)/ |
|---|---|---|
| ID | FUNCTION | INEXECUTABLE(0) |
| Y.1 | PRINT | 0 |
| Y.2 | SCAN | 1 |
| Y.3 | FAX TRANSMISSION | 1 |
| Y.4 | FAX RECEPTION | 1 |

TABLE 9

| ERROR TYPE | TRANSFER DESTINATION |
|---|---|
| USED-UP CONSUMABLE ITEM | — |
| PAPER JAM | — |
| PAPER-OUT | — |
| FAX TRANSMISSION | MFP1(IP ADDRESS: 192.168.0.1) |
| INEXECUTABLE | |
| MEMORY WRITE | — |

When a data transfer is executed from MFP 2 to MFP 1, as shown in aforementioned FIG. 3 and Table 2, a command and a parameter, which are used for determining a process, are attached to the head of the transferred data in MFP 2. In this example, a command of “2” and a parameter of “destination telephone number” are applied in order to request MFP 1 to execute a fax transmission.

In MFP 1, LAN control unit 12 receives the data transferred from MFP 2 and reception data processing unit 133 of controller 13 analyzes the received data. When it is determined that a fax transmission is requested according to the result of analyzing the command attached to the data, the received data is sent to fax board 19 and fax board 19 sends the data to a destination, on the PSTN line, specified by the parameter.

The above described operating procedures of the MFPs are the same as those in the first embodiment (FIGS. 4 and 5) and those explanations are omitted here. In the second embodiment, however, the aforementioned update process of the executable function information storage unit and update process of the transfer destination information storage unit based on the update process of the executable function information storage unit are executed during the operation of the operation flowcharts shown in FIGS. 4 and 5.

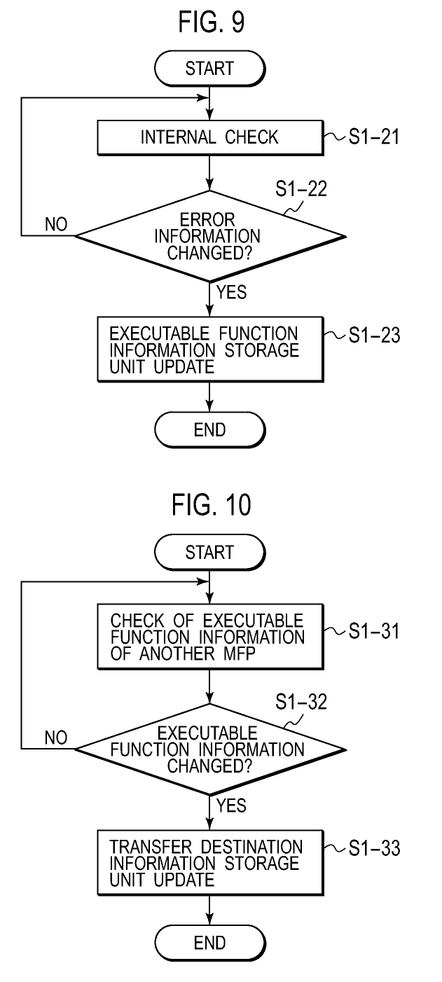

The update process in MFP 1 will further be described with reference to FIGS. 9 and 10.

FIG. 9 is an operation flowchart of an update process in the executable function information storage unit and FIG. 10 is an operation flowchart of an update process in the transfer destination information storage unit.

In step S1-21 of FIG. 9, error detection unit 131 of MFP 1 periodically checks error information of the MFP 1. When error detection unit 131 determines that there is a change in the error information in step S1-22, the process proceeds to step S1-23 and executable function information storage unit 201 is updated based on the error information.

At the same time, in step S1-31 of FIG. 10, transfer destination information update unit 134 of MFP 1 periodically checks the executable function information stored in executable function information storage unit 301 of the other MFP (MFP 2). When transfer destination information update unit 134 determines that there is a change in the executable function information in step S1-32, the process proceeds to step S1-33 and the content of transfer destination information storage unit 141 is updated based on the executable function information.

Note that, since the operations of these update processes in MFP 2 are the same as those of MFP 1, those explanations will be omitted here.

In the second embodiment, the number of MFPs on the network is two, however, may be three or more in the invention. If the number of MFPs in the network is three or more, a destination MFP in the transfer destination information storage unit can be changed automatically.

According to the above described second embodiment, in addition to the effects of the first embodiment, since a destination MFP for a proxy execution of a function is automatically updated corresponding to an error condition of each MFP on the network (LAN), a user's effort for setting information in the transfer destination information storage unit can be reduced. This effectively improves continuous usage of the MFPs.

Note that, in the second embodiment, error detection unit 131 or 231 updates executable function information storage unit 201 or 301 of the respective MFP 1 or 2, and transfer destination information update unit 134 or 234 monitors the content of executable function information storage unit 301 or 201 of the other MFP (MFP 2 or MFP 1) and, when a change is found in the content of executable function information storage unit 301 or 201 of the other MFP, updates information in transfer destination information storage unit 141 or 241 respectively. However, error detection unit 131 or 231 may transmit executable functions of the first MFP to the other MFP at a suitable interval (at fixed intervals or every time when an error occurs in and is removed from the first MFP, for example). This configuration can eliminate the executable function information storage unit in each MFP.

In the embodiments, information in the transfer destination information storage unit may be set by using a web page or an SNMP (Simple Network Management Protocol) via an operation panel, a web page or a utility.

In the embodiments, in addition to transferring data to a transfer destination, the destination MFP may transmit a data process result in the destination MFP to the sender MFP. Further, the sender MFP may transmit, to the transfer destination MFP, data which is previously converted into a format applicable to processing in the transfer destination MFP.

In the embodiments, MFPs are described as information processing apparatus; however, the invention is also applicable to a printer, a fax, a network scanner and the like.

Further, in the embodiments, the number of information processing apparatus on a network is not limited to two, and the invention can be used for three or more information processing apparatus. The availability of information processing apparatuses improves when more information processing apparatus are provided.

The invention includes embodiments other than those described in the above embodiments as long as these other embodiments do not depart from the spirit of the invention. The described embodiments are provided only for the purpose of describing the invention, and are not intended to limit the scope of the invention. The scope of the invention is defined by descriptions in the claims. Accordingly, the invention includes all forms having implications and ranges within the equivalent scope of the claims.

What is claimed is:

1. An information processing apparatus for use in an information processing system wherein plural information processing apparatuses communicate with one another via a network, comprising:
a network control unit capable of being connected to the network;
an error monitor configured to monitor if an error exists in the information processing apparatus; and
a controller configured to request another information processing apparatuses to execute a function which is inexecutable in the information processing apparatus due to an error in the information processing apparatus.

2. The information processing apparatus of claim 1 wherein
the controller is configured to execute a function requested by the other information processing apparatus.

3. The information processing apparatus of claim 2, further comprising
a transfer destination information storage unit storing executable function information in the apparatus based on a monitor result of the error monitor and capable of supplying the executable function information to the other information processing apparatus via the network control unit.

4. The information processing apparatus of claim 3, wherein
the controller configured to monitor executable function information of the other information processing apparatus via the network control unit and updates, based on the monitored information, a destination to request the execution of the inexecutable function out of plural information processing apparatus when an error occurs in the apparatus.

5. The information processing apparatus of claim 4, wherein
the network control unit is configured to receive the executable function information of the other information processing apparatus at intervals.

6. The information processing apparatus of claim 5, wherein
the error monitor is configured to monitor a first error and a second error, and
the information processing apparatus further comprising
a transfer destination information storage unit having a first transfer destination storage storing a first transfer destination corresponding to the first error among the other information processing apparatuses and a second transfer destination storage storing a second transfer destination corresponding the second error among the other information processing apparatuses, and
wherein the controller is configured to instruct the first transfer destination to execute a first inexecutable function due to the first error via the network control unit upon detecting an occurrence of the first error and to instruct the second transfer destination to execute a second inexecutable function due to the second error via the network control unit upon detecting an occurrence of the second error.

7. The information processing apparatus of claim 6, wherein
the function executable by the information processing apparatus includes at least one of printing, reading, fax transmission and fax reception; and
the first error and the second error correspond to one of a depleted consumable item error, a paper jam error, a paper-out error or a fax transmission inexecutable error.

8. The information processing apparatus of claim 6, further comprising
a transfer destination information update unit configured to update the first transfer destination of the first transfer destination storage and the second transfer destination of the second transfer destination storage stored in the transfer destination information storage unit among the other information processing apparatuses based on the executable function received from the other information processing apparatus.

9. The information processing apparatus of claim 5, further comprising
a transfer destination information storage unit storing a transfer destination corresponding to a depleted consumable item error, a transfer destination corresponding to a paper jam error, a transfer destination corresponding to a paper-out error, and a transfer destination corresponding to a fax transmission inexecutable error, respectively, and wherein
the controller includes a transfer destination information update unit configured to update information in the transfer destination information storage unit based on the executable function information received from the other information processing apparatus, and wherein the received executable function information shows whether the other information processing apparatus is able to execute at least one of print, scan, fax transmission, fax reception, or memory write functions.

10. The information processing apparatus of claim 1, wherein
the controller is configured to send executable function information in the information processing apparatus based on a monitor result of the error monitor to the other information processing apparatus via the network control unit.

11. The information processing apparatus of claim 1, wherein
the controller is configured to receive executable function information of the other information processing apparatus via the network control unit and updates, based on the received information, a destination to request the execution of the inexecutable function when an error occurs in the information processing apparatus.

12. The information processing apparatus of claim 11, wherein
the network control unit is configured to receive the executable function information of the other information processing apparatus at intervals.

13. The information processing apparatus of claim 12, further comprising
a transfer destination information storage unit storing a transfer destination corresponding to a depleted consumable item error, a transfer destination corresponding to a paper jam error, a transfer destination corresponding to a paper-out error, and a transfer destination corresponding to a fax transmission inexecutable error, respectively, and
wherein the controller includes a transfer destination information update unit configured to update information in the transfer destination information storage unit based on the executable function information received from the other information processing apparatus, wherein the received executable function information shows whether the other information processing apparatus is able to execute at least one of print, scan, fax transmission, fax reception, or memory write functions.

14. The information processing apparatus of claim 1,
wherein the error monitor is configured to monitor a first error and a second error,
the information processing apparatus further comprising
a transfer destination information storage unit having a first transfer destination storage storing a first transfer destination corresponding to the first error among the other information apparatuses and a second transfer destination storage storing a second transfer destination corresponding to the second error among the other information apparatuses, and
wherein the controller is configured to instruct the first transfer destination to execute an inexecutable function due to the first error upon detecting an occurrence of the first error and to instruct the second transfer destination to execute an inexecutable function due to the second error upon detecting an occurrence of the second error.

15. The information processing apparatus of claim 14, wherein
a function executable by the information processing apparatus includes at least one of printing, reading, fax transmission and fax reception; and
the first error and the second error correspond to one of a depleted consumable item error, a paper jam error, a paper-out error or a fax transmission inexecutable error.

16. The information processing apparatus of claim 14 further comprising
a transfer destination information update unit configured to update, among the other information processing apparatuses, the first transfer destination of the first transfer destination storage and the second transfer destination of the second transfer destination storage stored in the transfer destination information storage unit based on the executable function received from the other information processing apparatus.

17. The information processing apparatus of claim 16 wherein the transfer destination information storage unit stores a transfer destination corresponding to a depleted consumable item error, a transfer destination corresponding to a paper jam error, a transfer destination corresponding to a paper-out error, and a transfer destination corresponding to a fax transmission inexecutable error, respectively.

18. An information processing system comprising:
a first information processing apparatus communicating with a second information processing apparatus via a network;
the first information processing apparatus comprising a first network control unit connected to the network, a first error monitor configured to monitor if an error exists in the first information processing apparatus, and a first controller configured to request the second information processing apparatus to execute a function which is inexecutable in the first information processing apparatus due to an error in the first information processing apparatus; and wherein
the second information processing apparatus comprises a second network control unit connected to the network, a second error monitor configured to monitor if an error exists in the second information processing apparatus, and a second controller configured to request the first information processing apparatus to execute a function that is inexecutable in the second information processing apparatus due to an error in the second information processing apparatus.

19. The information processing system of claim 18 wherein the first controller is configured to execute a function requested by the second information processing apparatus and the second controller is configured to execute a function requested by the first information processing apparatus.

20. An information processing apparatus capable of operation in the system of claim 18.
